(19) United States
(12) Patent Application Publication
(10) Pub. No.: US 2026/0067169 A1
(43) Pub. Date: Mar. 5, 2026

(54) AUTOENCODER BASED ANOMALY DETECTION AND EFFICIENT STORAGE OF METRICS DATA WITHIN A CLOUD ENVIRONMENT

(71) Applicant: Oracle International Corporation, Redwood Shores, CA (US)

(72) Inventors: Kourosh Lashgari, Seattle, WA (US); Shant Karakashian, Wayland, MA (US)

(73) Assignee: Oracle International Corporation, Redwood Shores, CA (US)

(21) Appl. No.: 18/821,022

(22) Filed: Aug. 30, 2024

(51) Int. Cl. H04L 41/142; H04L 43/04; H04L 43/0811

(52) U.S. Cl. CPC H04L 41/142; H04L 43/04; H04L 43/0811

(57) ABSTRACT

Techniques for autoencoder based anomaly detection and efficient storage of metrics within a cloud environment are disclosed. In an example, an input data stream is received from a cloud resource operating within a cloud environment, input data stream indicative of a metric associated with the cloud resource. An autoencoder (i) encodes the input data stream to generate a reduced size data stream, (ii) decodes the reduced size data stream to generate an output data stream that is an estimated reconstruction of the input data stream, (iii) compares the input and output data stream, to generate a stream of reconstruction errors, and (iv) generates a stream of z scores, based on the stream of reconstruction errors. In an example, one or more data points within the input data stream are flagged as being anomalous data points, based at least in part on the stream of z scores.

### BACKGROUND

A cloud provider provides on-demand, scalable computing resources (e.g., a cloud environment) to its cloud customers. A cloud environment includes a plethora of cloud resources, such as different types of physical and virtual resources offered by the cloud provider. Health of such cloud resources is vital for proper operation of the cloud environment. In an example, large volume of metrics data is generated from such cloud resources. Monitoring, storing, analyzing, and/or interpreting such a large volume of metrics data is a challenging task.

### BRIEF SUMMARY

In various embodiments, a non-transitory computer-readable medium includes instructions that when executed by one or more processors, cause a system including the one or more processors to perform operations including receiving, from a cloud resource operating within a cloud environment, an input data stream indicative of a metric associated with the cloud resource, the input data stream including a plurality of data points indicative of values of the metric at a corresponding plurality of points in time; encoding, by an autoencoder, the input data stream to generate a reduced size data stream; decoding, by the autoencoder, the reduced size data stream to generate an output data stream that is an estimated reconstruction of the input data stream; comparing the input data stream and the output data stream, to generate a stream of reconstruction errors; generating a stream of z scores, based at least in part on the stream of reconstruction errors; and flagging one or more data points within the input data stream as being anomalous data points, based at least in part on the stream of z scores. In an example, flagging the one or more data points within the input data stream as being anomalous data points comprises in response to one or more z scores of the stream of z scores being higher than a corresponding one or more thresholds, flagging the one or more data points within the input data stream as being anomalous data points.

In an example, flagging the one or more data points within the input data stream as being anomalous data points comprises generating (i) a first z score corresponding to a first data point of the input data stream, (ii) a second z score corresponding to a second data point of the input data stream, and (iii) a third z score corresponding to a third data point of the input data stream; comparing each of the first and second z scores with a first threshold, and comparing the third z score with a second threshold; in response to the first z score being higher than the first threshold, flagging the first data point within the input data stream as being an anomalous data point; in response to second z score being lower than the first threshold, determining that the second data point within the input data stream is a non-anomalous data point; and in response to third z score being higher than the second threshold, flagging the third data point within the input data stream as being an anomalous data point. In an example, the first threshold is different from the second threshold. In an example, the operations further include determining the first threshold, based at least in part on a first time and a second time at which the first data point and the second data point, respectively, were generated; and determining the second threshold, based at least in part on a third time at which the third data point was generated. In an example, the operations further include determining the first and second thresholds dynamically, based at least in part on a distribution of reconstruction errors observed during a training phase of the autoencoder. In an example, the input data stream is a first input data stream, the reduced size data stream is a first reduced size data stream, the output data stream is first output data stream, the stream of reconstruction errors is first stream of reconstruction errors, and the stream of z scores is a first stream of z scores, and wherein the operations further include receiving, from the cloud resource operating within a cloud environment, a second input data stream indicative of another metric associated with the cloud resource; encoding, by the autoencoder, the second input data stream to generate a second reduced size data stream; decoding, by the autoencoder, the second reduced size data stream to generate a second output data stream that is an estimated reconstruction of the second input data stream; comparing the second input data stream and the second output data stream, to generate a second stream of reconstruction errors; and corelating the first stream of reconstruction errors and the second stream of reconstruction errors, to detect the one or more data points within the first input data stream and another one or more data points within the second input data stream as being anomalous data points.

In an example, the operations further include storing the reduced size data stream, wherein a size of the reduced size data stream is less than a size of the input data stream. In an example, the operations further include storing the input data stream and the reduced size data stream; and deleting the stored input data stream after a period of time, without deleting the reduced size data stream. In an example, the reduced size data stream is stored in a Parquet format. In an example, the input data stream is a first input data stream, the metric is a first metric, and wherein the operations further include generating, from the cloud resource operating within the cloud environment, a second input data stream indicative of a second metric associated with the cloud resource; and generating, from the second input data stream, the first input data stream indicative of the first metric associated with the cloud resource, wherein the first metric is a statistic measure or a reliability measure. In an example, the statistic measure or the reliability measure comprises a statistic measure including one of a total count of data points of the second input data stream within a sequence of time windows, a maximum value of the data points of the second input data stream within the sequence of time windows, a minimum value of the data points of the second input data stream within the sequence of time windows, a mean value of the data points of the second input data stream within the sequence of time windows, a P95 value of the data points of the second input data stream within the sequence of time windows. In an example, the statistic measure or the reliability measure comprises a reliability measure including one of a mean time between failures of the cloud resource within a sequence of time windows, percentage availability of the cloud resource within a sequence of time windows, and a weighted moving average of the first metric within a sequence of time windows.

In an example, the input data stream is a first input data stream, and wherein the operations further include training the autoencoder using a plurality of input data streams that (i) excludes the first input data stream and (ii) that includes at most a threshold number of anomalous data points. In an example, the operations further include in response to the one or more data points within the input data stream being flagged as being anomalous data points, causing to at least one of (i) detect an erroneous operation of the cloud resource or (ii) rectify an erroneous operation of the cloud resource.

In various embodiments, a method comprises receiving, from a cloud resource operating within a cloud environment, an input data stream indicative of a metric associated with the cloud resource, the input data stream including a plurality of data points indicative of values of the metric at a corresponding plurality of points in time; encoding, by an autoencoder, the input data stream to generate a reduced size data stream; decoding, by the autoencoder, the reduced size data stream to generate an output data stream that is an estimated reconstruction of the input data stream; comparing the input data stream and the output data stream, to generate a stream of reconstruction errors; generating a stream of z scores, based at least in part on the stream of reconstruction errors; and flagging one or more data points within the input data stream as being anomalous data points, based at least in part on the stream of z scores. In an example, flagging the one or more data points within the input data stream as being anomalous data points comprises in response to one or more z scores of the stream of z scores being higher than a corresponding one or more thresholds, flagging the one or more data points within the input data stream as being anomalous data points. In an example, the input data stream is a first input data stream, and wherein the method further comprises training the autoencoder using a plurality of input data streams that (i) excludes the first input data stream and (ii) that includes at most a threshold number of anomalous data points.

In various embodiments, a system comprises one or more processors; a storage repository; and one or more non-transitory computer-readable media storing instructions, which, when executed by the system, cause the system to perform a set of actions including: receiving, from a cloud resource operating within a cloud environment, an input data stream indicative of a metric associated with the cloud resource, the input data stream including a plurality of data points indicative of values of the metric at a corresponding plurality of points in time; encoding, by an autoencoder, the input data stream to generate a reduced size data stream; storing the reduced size data stream in the storage repository; decoding, by the autoencoder, the reduced size data stream to generate an output data stream that is an estimated reconstruction of the input data stream; comparing the input data stream and the output data stream, to generate a stream of reconstruction errors; generating a stream of z scores, based at least in part on the stream of reconstruction errors; and flagging one or more data points within the input data stream as being anomalous data points, based at least in part on the stream of z scores. In an example, flagging the one or more data points within the input data stream as being anomalous data points comprises: in response to one or more z scores of the stream of z scores being higher than a corresponding one or more thresholds, flagging the one or more data points within the input data stream as being anomalous data points. In an example, the input data stream is a first input data stream, the metric is a first metric, and wherein the operations further include: generating, from the cloud resource operating within the cloud environment, a second input data stream indicative of a second metric associated with the cloud resource; and generating, from the second input data stream, the first input data stream indicative of the first metric associated with the cloud resource, wherein the first metric is a statistic measure or a reliability measure.

In some embodiments, a system comprises one or more processors; and one or more non-transitory computer-readable media storing instructions, which, when executed by the system, cause the system to perform a set of actions including monitoring a plurality of target interactions of a target user with an item providing platform; receiving a plurality of target recommendations for the target user from a recommendation system of the item providing platform; and inferring, using an attack classifier and based on (i) the plurality of target interactions and (ii) the plurality of target recommendations, whether at least a subset of the plurality of target interactions and/or at least a subset of the plurality of target recommendations were used to train the recommendation system, wherein the attack classifier is trained using training data associated with a plurality of autonomous users interacting with the item providing platform. In an example, the item providing platform is one of a video providing platform, an audio providing platform, or a shopping platform.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1A illustrates a block diagram of a cloud environment comprising (i) a plurality of cloud resources generating a plurality of data streams, and (ii) an autoencoder configured to (A) selectively detect anomalies within the plurality of data streams and (B) modify the plurality of data streams to generate a plurality of reduced size data streams, e.g., for size efficient storage of the plurality of reduced size data streams.

FIG. 1B illustrates examples of a first data stream collected by a data collection service and a second data stream generated by a metric processing service of the cloud environment of FIG. 1A.

FIG. 2 illustrates an autoencoder, such as the autoencoder of FIG. 1A.

FIG. 3A illustrates example data points of an example data stream.

FIG. 3B illustrates the z score for various the data points for the data stream of FIG. 3A.

FIG. 4 is a flow diagram depicting a method of using an autoencoder for anomaly detection and/or efficient storage of metrics data within a cloud environment.

FIG. 5 depicts a simplified diagram of a distributed system for implementing certain aspects.

FIG. 6 is a simplified block diagram of one or more components of a system environment by which services provided by one or more components of an embodiment system may be offered as cloud services, in accordance with certain aspects.

FIG. 7 illustrates an example computer system that may be used to implement certain aspects.

### DETAILED DESCRIPTION

As described above, a cloud environment includes a plethora of cloud resources, such as different types of physical and virtual cloud resources offered by the cloud provider. Such cloud resources generate large volume of metrics data, where such metrics data are indicative of a health and/or operation of the cloud resources.

In an example, due to the high volume of metrics data emissions and consequent requirement of high storage volume to storage the metrics data, such metrics data may be retained for a relatively short period of time (such as one or two weeks), making it difficult to understand the historic behavior of the cloud resources over a long period of time. Due to such inability of storing such historical data, it may be difficult to forecast behavior of such cloud resources. Additionally or alternatively, the complexity in isolating specific metric dimensions related to a specific data channel (or data behavior) makes manual analysis of such large volume of metrics data impractical.

Accordingly, techniques are described below, in which the volume of such metrics data is reduced, without losing substantially fidelity and with relatively less distortion or loss of information. The techniques are also helpful in detection of anomaly within the metrics data, which aids in prediction of failure or other potential issues with the cloud resources. Specifically, this disclosure discusses an autoencoder that summarizes the metrics data in a compressed form, which is size efficient for storage purposes, where the compressed form of the metrics data retains relevant information of the uncompressed raw metrics data. Additionally (or alternatively), the autoencoder also automates real-time surveillance of metrics from various data channels, and automates detection of anomalies within the metrics data. Detection of such anomalous data can facilitate in prediction and/or detection of potentials issues with cloud resources, as well as provide insights of the health and operation of the various cloud resources of the cloud environment, in an example.

The techniques described herein can be implemented in different stages. Initially, metrics data are collected from various cloud resources of the cloud environment, where examples of such cloud resources are described below in further detail. The metrics data are collected as data streams. For example, each cloud resource generates one or more metrics data streams (these data streams are termed “metrics” data streams, to differentiate these data streams from one or more other types of data streams described herein). A metrics data stream includes a plurality of data points indicative of values of the metric at a corresponding plurality of points in time. Thus, in an example, a metrics data stream is a time series of data points indicative of the metric associated with the cloud resource being monitored.

The metric being measured may be, merely as examples, any of a percentage usage of the cloud resource, a latency associated with the cloud resource, a number of request processed by the cloud resource per unit of time, etc. Thus, each metrics data stream includes a corresponding time series data, such as a metric associated with a corresponding cloud resource at a periodic or aperiodic time, such as a value of the metric every 1 second, or every 2 seconds, or every 10 seconds, or every minute, or the like.

In an example, one or more statistical data streams and/or one or more reliability data streams may be generated from each metrics data stream. For example, a statistical data stream includes a corresponding statistical measure associated with the metric of the corresponding metrics data stream. Similarly, a reliability data stream includes a corresponding reliability measure associated with the metric of the corresponding metrics data stream. Examples of the statistical measure include one or more of the following statistical measures: (i) a total count, (ii) a maximum value, (iii) a minimum value, (iv) a mean value, (v) a P95 value (or a 95th percentile value), and/or the like, each of which are described below in further detail. Examples of the reliability measure include one or more of the following reliability measures: (i) a mean time between failures (MTBF), (ii) failure rate, (iii) a mean time between critical failures (MTBFC), (iv) an availability of a cloud resource, (v) a weighted moving average, and/or the like, each of which are described below in further detail.

In an example, in a subsequent stage of the techniques described herein, an autoencoder is trained using a plurality of metrics data streams, statistical data streams, and/or reliability data streams, which are collectively referred to herein as input data streams (e.g., as they are input to the autoencoders). The autoencoder is a type of artificial neural network used for unsupervised learning tasks. In an example, the autoencoder may be used for learning efficient coding of an input data stream by capturing relevant features or patterns of the input data stream, while discarding redundant or less relevant information. The autoencoder learns how to take in an input data stream, compress the input data stream, and then reconstruct the input data stream from the compressed data stream. The reconstruction is based on the expected system behavior that the autoencoder was trained on.

In an example, the autoencoder comprises an encoder and a decoder. The encoder receives an input data stream having a relatively higher dimension, and compresses the input data stream into a latent-space representation, also referred to as a reduced dimensional intermediate or compressed data stream. The dimensionality of the compressed data stream is less than that of the input data stream. The compressed data stream is a summarized representation of the input data stream.

The autoencoder further comprises a decoder that outputs a reconstructed full dimensional output data stream from this compressed data stream. In an example, the autoencoder aims to reconstruct the input data stream as the output data stream. For example, the autoencoder may be trained to minimize the difference between the input data stream and its reconstruction version (which is the output data stream). Thus, the output data stream is a reconstructed estimate of the input data stream. In an example, a loss function is used to train the autoencoder. The reconstruction by the decoder is based on the expected system behavior that the autoencoder was trained on.

In anomaly detection techniques described herein (e.g., where the autoencoder is trained to detect anomalous data points within the input data stream), the autoencoder learns to represent normal or non-anomalous data patterns during the training phase. For example, the autoencoder is trained using such normal or non-anomalous data patterns of the input data streams. Here normal data pattern implies regular or normal data points (such as or non-anomalous data points) of the input data streams received by the autoencoder. For example, the normal or non-anomalous data pattern of a data stream implies that the data stream does not include any major anomalous data points, as described below in further detail.

Assume that the autoencoder is trained using such normal or non-anomalous data patterns of the input data streams. Subsequently, during inference stage, when an input data stream comprising non-anomalous data points is fed to the trained autoencoder, the trained autoencoder can output a reconstructed output data stream that is a reasonable estimate of the input data stream. However, if at least a part of the input data stream fed to the autoencoder has anomalous data points, the trained autoencoder may not be able to correctly or relatively accurately reproduce such anomalous data points at the output data stream.

Thus, when new data input streams are fed through the trained autoencoder, the network of the autoencoder can accurately reconstruct non-anomalous data points, but may be at least in part unable to reconstruct anomalous data points, resulting in higher reconstruction errors for such anomalous data points of the input data stream. Here reconstruction error associated with a data point of an input data stream is based on a difference between the data point of the input data stream and a corresponding data point of the output data stream.

For example, the autoencoder is trained with non-anomalous data points of one or more input data streams. During inference stage of the trained autoencoder, when anomalous data points are fed to the trained autoencoder, the trained autoencoder (such as the decoder) is unable to reconstruct the anomalous data points after the encoder has compressed and reduced the size of the input data stream. If the data points are anomalous, the reconstructed output data points significantly deviate from the input data. The autoencoder (such as an anomaly detection service of the autoencoder) measures the difference between the input and the output data points with statistical means. This distance, when crosses a certain threshold, indicates anomaly in the data points, as described below in further detail.

In an example, the above-described threshold may be dynamically adjusted, e.g., by a human operator, automatically, or by a machine learning model. The threshold may be adjusted based on a time of the day, a day of the week, based on sessional or otherwise expected temporal variations in the data points, and/or based on a distribution of the reconstruction errors observed during the autoencoder training of metrics data from metrics to identify anomalies, as described below in further detail.

In an example, the compressed data stream corresponding to an input data stream has a smaller size than that of the input data stream. Accordingly, the compressed data stream may be stored for a longer duration of time, while the input data stream is deleted periodically. Thus, the autoencoder makes storage of large volume of metrics data possible, without significant loss of fidelity in the metrics data. For example, the reduced size compressed data streams are more storage efficient than the full-sized input data streams.

In an example, the autoencoder may sequentially or at least in part (or fully) parallelly process multiple data streams. For example, it may be advantageous to process multiple data streams at once, as this allows the autoencoder to learn the relationships between different metrics of the different data streams. For example, two or more data streams may be correlated to each other, and the autoencoder may also be trained to analyze the interdependencies and correlations between these two data streams, e.g., for multivariate anomaly detection, as described below in further detail.

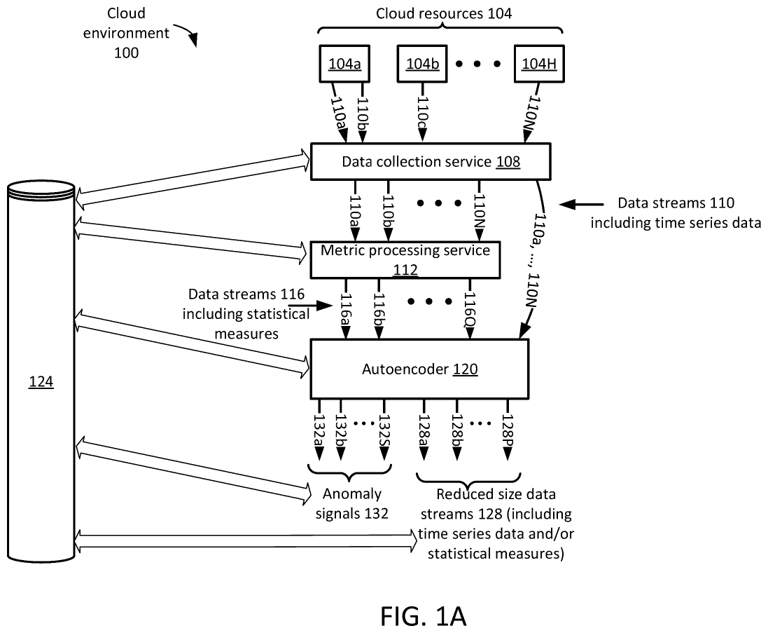

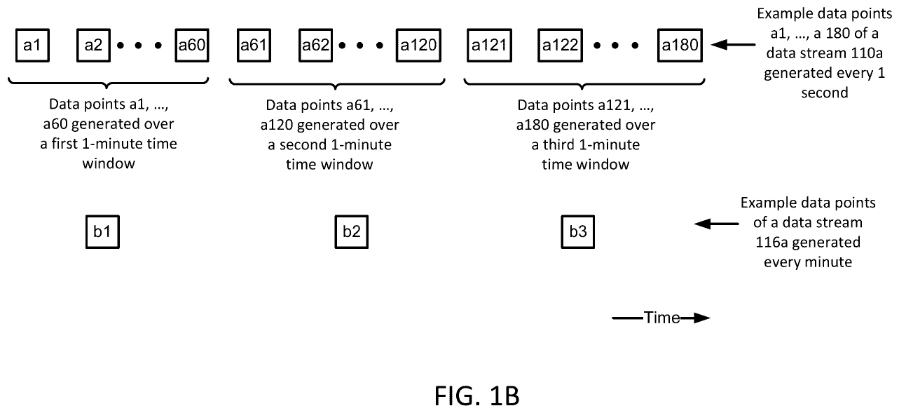

FIG. 1A illustrates a block diagram of a cloud environment 100 comprising (i) a plurality of cloud resources 104a, . . . , 104H generating a plurality of data streams 110a, . . . , 110N, and (ii) an autoencoder 120 configured to (A) selectively detect anomalies within the plurality of data streams 110a, . . . , 110N and (B) modify the plurality of data streams 110a, . . . , 110N to generate a plurality of reduced size data streams 128a, . . . , 128P, e.g., for size efficient storage of the plurality of reduced size data streams 128a, . . . , 128P.

The cloud environment 100 provides cloud services to a plurality of cloud customers. For example, the cloud environment 100 offers computing services to the cloud customers, such as servers, storage, databases, networking, software, analytics, intelligence, and/or the like, to the cloud customers and over a network (such as the Internet). The cloud resources 104a, . . . , 104H can be any appropriate physical or virtual resources provided by the cloud environment 100, such as processing units, memory, virtual machines, physical or virtual networking components, gateways, one or more services provided by physical and/or virtual components of the cloud environment 100, and/or other computing or storage resources within a cloud environment. The cloud resources 104a, . . . , 104H operate to provide cloud services to the cloud customers.

In an example, each of one or more cloud resources 104a, . . . , 104H generates one or more data streams 110, such as the plurality of data streams 110a, . . . , 110N. The plurality of data streams 110a, . . . , 110N are collected by a data collection service 108 of the cloud environment 100. Merely as an example, the cloud resource 104a may generate the data streams 110a and 110b, the cloud resource 104b may generate the data stream 110c, and so on. In an example, instead of a cloud resource 104 generating a data stream 110, the data stream 110 may be generated by the data collection service 108, e.g., based on an operation of the cloud resource 104. In any case, in an example, a data stream 110 corresponds to (such as is at least in part representative of) an operation of the corresponding cloud resource 104.

Merely as an example, the cloud resource 104a is a processing unit, and a first corresponding data stream 110a is representative of a usage of the cloud resource 104a. For example, the data stream 110a comprises a time series of data, where the data stream 110a includes data representative of a percentage usage of the cloud resource 104a every one second (or every two seconds, or every fifteen seconds, or the like). In an example, a second corresponding data stream 110b is representative of a latency associated with the cloud resource 104a. For example, the data stream 110b comprises a time series of data, where the data stream 110b includes data representative of a latency associated with the cloud resource 104a every one second (or every two seconds, or every fifteen seconds, or the like).

Thus, each data stream 110 includes a corresponding time series data, such as a metric associated with a corresponding cloud resource at a periodic or aperiodic time interval, such as a value of the metric every 1 second, or every 2 seconds, or every 10 seconds, or every minute, or the like. Some such examples of the metrics associated with the various data streams 110a, . . . , 110N include one or more of a percentage usage of a cloud resource, a data throughout by a cloud resource, a latency associated with a cloud resource, requests per time interval (such as requests/second) processed by a cloud resource, and/or the like.

In an example, the cloud environment 100 comprises a storage repository 124. The data collection service 108 stores the data streams 110a, . . . , 110N within the storage repository 124. In an example, the data collection service 108 stores the data streams 110a, . . . , 110N only temporarily, and deletes older data points of the data streams 110a, . . . , 110N in a rolling window fashion. For example, assume that the data stream 110a comprises a time series data representing a usage of a corresponding cloud resource 104. The data stream 110a is generated in real or near-real time and in a periodic manner (such as every second). Once older data points have been processed by the cloud environment 100, such older data points of the data stream 110a may optionally be deleted from the storage repository 124. As will be described below, among other things, the cloud environment 100 (such as the autoencoder 120) generates a reduced sized data stream 128a corresponding to the data stream 110a, and the reduced sized data stream 128a may be stored within the storage repository 124, where the reduced sized data stream 128a may be a summarized or high-level representation of the data stream 110a. Accordingly, older data points of the data stream 106a may be deleted from the storage repository 124. For example, data points of the data stream 110a, which are more than a week old (or more than 3 days old, or more than 1 day old, or more than 6 hours old, or more than 1 hour old, for example), may be deleted from the storage repository 124.

In an example, the data streams 110a, . . . , 110N are processed by a metric processing service 112, to generate a plurality of plurality of data streams 116a, . . . , 116Q including statistical and/or reliability measures. The metric processing service 112 stores the data streams 116a, . . . , 116Q within the storage repository 124. In an example, the metric processing service 112 stores the data streams 116a, . . . , 116Q only temporarily, and deletes older data points of the data streams 116a, . . . , 116Q in a rolling window fashion (e.g., as described above with respect to the data streams 110).

The data streams 110a, . . . , 110N include metrics associated with the cloud resources 104a, . . . , 104H, whereas the data streams 116a, . . . , 116Q include statistical and/or reliability measures associated with the data streams 110a, . . . , 110N. Accordingly, the data streams 110a, . . . , 110N are also referred to herein as metric data streams, whereas the data streams 116a, . . . , 116Q are also referred to herein as statistical and/or reliability measure data streams.

The metric processing service 112 may process a data stream 110 to generate corresponding one or more of the data streams 116a, . . . , 116Q. Merely as an example, the data stream 110a may be processed to generate data streams 116a, 116b, . . . , 116f.

In an example, one or more of the data streams 116a, . . . , 116Q include, for one or more of the metric-based data stream 110a, . . . , 110N, one or more of the following statistical measures: (i) a total count, (ii) a maximum value, (iii) a minimum value, (iv) a mean value, (v) a P95 value (or a 95th percentile value), and/or the like.

For example, a data stream 110 comprises a metric collected in real or near real time as time series data, structured into sequences of time-windows. Within each time-window, one or more statistical measures are calculated for the metric associated with the corresponding data stream 110.

Merely as an example, assume that the data stream 110a comprises a percentage utilization of a cloud resource 104a, where the percentage utilization is recorded every second (for example). In such an example, the data stream 116a may be divided in 1-minute sequences of time windows (again, as an example). For each such 1-minute time window, the statistical measures are determined by the metric processing service 112, where the statistical measures include one or more of a total count of data points within the time window, a maximum value of the data points within the time window, a minimum value of the data points within the time window, a mean value of the data points within the time window, a P95 value of the data points within the time window, and/or the like, and a data stream 116 includes a corresponding such statistical measure. For example, the data stream 116a may include data points including a total count, the data stream 116b may include data points including a maximum value, the data stream 116b may include data points including a minimum value, and so on.

In an example, the total count measures the overall volume of activity or events or data points within a specific period (such as each 1-minute of the time window), providing a quantitative measure of load or usage. Trends can be analyzed over time, with sudden increases or decreases indicating potential anomalies.

The maximum value identifies the highest value within a specific time window, which may be used for understanding peak loads and stress points. This facilitates, in an example, in capacity planning by understanding peak demands and ensuring the system can handle such loads. The minimum value identifies the lowest value within a specific time window, which may facilitate in understanding periods of low activity or resource usage. The mean provides the central tendency of the data points within the time window, offering an average value over the time window. Comparing metric values against the mean helps identify outliers, with values significantly higher or lower than the mean flagged as anomalies. Mean values over different periods (e.g., daily, weekly) help understand normal seasonal variations, aiding in anomaly detection. The P95 value highlights an upper range of the data, often where anomalies lie, and may be useful for identifying spikes and/or unusually high values. Aggregating data to a single value per metric per time window simplifies the dataset, making it more manageable.

In an example, collecting and analyzing these statistical measures of the data streams 116a, . . . , 116Q facilitate in effectively understand the behavior of the various cloud resources 104a, . . . , 104H of the cloud environment 100 over time, and facilitate in identifying anomalies that may indicate issues or opportunities for optimization.

In an example, a size of a data stream 116 is less than a size of a corresponding data stream 110. For example, assume that the data stream 110a includes data points measured every 1 second. Also, assume that the data stream 116a indicates a maximum value of the data points of the data stream 110a over sequences of a time window (such as a 1-minute time window). For example, data points of the data stream 116a are generated every 1 minute, and each data point of the data stream 116a is representative of a maximum of the data points of the data stream 110a over the last 1 minute. Thus, in this example, while data points of the data stream 110a are generated every second, and data points of the data stream 1106 are generated every minute. Accordingly, the data stream 116a has a lower storage requirement compared to the data stream 110a.

FIG. 1B illustrates examples of a first data stream 110a collected by a data collection service 108 and a second data stream 116a generated by a metric processing service 112 of the cloud environment 100 of FIG. 1A. In the example of FIG. 1B and as also described above, the data stream 110a comprises data points a1, a2, . . . , a180, generated at an interval of 1 second (for example). The data stream 116a is representative of a statistical measure of the data stream 110a, such as a maximum value of the data points of the data stream 110 over a sequence of time window. The time window is 1 minute in the example of FIG. 1B. Thus, for example, for the first 1-minute time window, a data point b1 of the data stream 116a is representative of a maximum value of the data points a1, . . . , a60 of the data stream 110a. For the second 1-minute time window, a data point b2 of the data stream 116a is representative of a maximum value of the data points a61, . . . , a120 of the data stream 110a. For the third 1-minute time window, a data point b3 of the data stream 116a is representative of a maximum value of the data points a121, . . . , a180 of the data stream 110a, as illustrated in FIG. 1. Accordingly, the data stream 116a has a lower storage requirement compared to the data stream 110a.

In an example, in addition to (or instead of) the statistical measures, one or more of the data streams 116a, . . . , 116Q include, for one or more of the metric-based data stream 110a, . . . , 110N, one or more of the following reliability measures: (i) a mean time between failures (MTBF), (ii) failure rate, (iii) a mean time between critical failures (MTBFC), (iv) an availability of a cloud resource, (v) a weighted moving average, and/or the like.

For example, a data stream 110 comprises a metric collected in real or near real time as time series data, structured into sequences of time-windows. Within each time-window, one or more reliability measures are calculated for the metric associated with the corresponding data stream 110.

Merely as an example, assume that the data stream 110c is representative of a metric indicative of an operation of a cloud resource 104a, where the metric is recorded every second (for example). In such an example, a corresponding data stream 116f (which is generated from the data stream 110c by the metric processing service 112) may be divided in a 1-minute sequence of time windows (again, as an example, see FIG. 1B). For each such 1-minute time window, the reliability measures are determined by the metric processing service 112. Thus, the reliability measures or reliability metrices are computed (e.g., by the metric processing service 112) for the service or cloud resource being analyzed. The reliability metrics of the data streams 116a, . . . , 116Q may computed in real time or near real-time, as the cloud resources 104a, . . . , 104H are generating the data streams 110a, . . . , 110N.

In an example, the mean time between failures MTBF is defined as:

$$MTBF = \frac{total operation time}{number of failures} . \qquad Equation l$$

The total operation time can be set to a suitable time period, such as 1 day, or 1 week, or the like. The MTBF may be updated as and when new data points of the data streams 110a, . . . , 110N are generated. In an example, the MTBF may be generated for one or more, such as each of the data streams 110a, . . . , 110N (e.g., a corresponding data stream 116, such as data stream 116g, may be a time series reliability metric representative of a MTBF of a corresponding data stream 110a, for example).

In an example, a failure rate of a cloud resource 104 can be defined as follows:

$$Faliure rate = \frac{1}{MTBF} * 100. \qquad Equation 2$$

A failure of a cloud resource 104 may corresponding to a situation where the availability of the cloud resource drops below a configurable threshold level.

In an example, a mean time between critical failures (MTBCF) is associated specifically with critical failures that significantly impact the performance or availability of at least a portion of the cloud environment 100. For example, if a cloud resource is critical in providing at least a part of a service to a cloud customer, the cloud resource may be considered as a critical cloud resource. A failure of such a critical cloud resources may be associated with MTBCF. As described above, a failure of a cloud resource 104 may corresponding to a situation where the availability of the cloud resource drops below a configurable threshold level. In an example, the MTBCF provides insights into a reliability of one or more critical components of the cloud environment 100.

In an example, a MTBCF of a critical cloud resource 104 can be defined as follows:

$$MTBCF = \frac{Total operation time}{Number of critical failures} . \qquad Equation 3$$

The total operation time can be set to a suitable time period, such as 1 day, or 1 week, or the like. The MTBF may be updated as and when new data of the data streams 110a, . . . , 110N are generated. For example, if the time period (e.g., the total operation time) is set to 1 week (or 168 hours) and there are 5 critical failures of a critical cloud resource, then the MTBCF at the end of the 1-week period is 168/5=33.6, which is the mean time between critical failures (e.g., on an average, a critical failure occurs every 33.6 hours). The MTBCF provides insights into the reliability of the critical components of the cloud environment 100. Alternatively, the MTBCF may be computed at the second level granularity, or minute level granularity, or hour level granularity, or day level granularity (e.g., instead of 1 week). Note that as and when time progresses, new values of the MTBCF (as well as other reliability metrices) are updated, such that the MTBCF at different points in time are expressed as data points in a data stream 116.

In an example, an availability of a cloud resource 104 is a percentage of time the cloud system is operational and provides its intended services. Availability is defined as:

$$Availability = \frac{( T - D )}{T} * 100. \qquad Equation 3 A$$

T is the total operational time, which can be set to a suitable time period, such as 1 day, or 1 week, or the like. D is the downtime of the cloud resource for which the availability is being calculated. A downtime D may be a total accumulated time when the cloud resource experiences failures or is unavailable during the time period T. The availability may be updated as and when new data of the data streams 110a, . . . , 110N are generated. In an example, the availability may be generated for one or more, such as each of the data streams 110a, . . . , 110N (e.g., a corresponding data stream 116, such as data stream 116h, may be a time series reliability metric representative of an availability of a corresponding data stream 110a, for example).

A weighted moving average (WMA) represented by a data stream 116 detects trends and gradual changes in the data points of the corresponding data stream 110, and may be useful for identifying slow-developing anomalies, capacity forecasting, and/or general planning. In an example, the weighted moving average of the data points of a corresponding data stream 110 may be measured using a suitable technique for calculating a weighted moving average of a plurality of data points over a suitable moving time window.

Note that while the data points of the data streams 110a, . . . , 110N are generated at a smaller time interval, the data points of the data streams 116a, . . . , 116Q are generated at a longer time interval, e.g., as described above with respect to FIG. 1B. Merely as an example, the data stream 110a may be representative of a usage of a cloud resource 104a, and may be generated every second, for example. The statistic or reliability measure of a corresponding data stream 116a (which may be derived from the data stream 110a) may in turn be generated for every 10 seconds, or every 30 seconds, or every minute, or every hour, or every day, or every 7 days, for example (in FIG. 1B, the data points of the data stream 116a is generated every 1 minute). Thus, storing the data streams 116a, . . . , 116Q are relatively more storage capacity efficient than storing the data streams 110a, . . . , 110N, in an example.

In an example, collecting and analyzing these statistical and/or reliability measures of the data streams 116a, . . . , 116Q facilitate in effectively understanding the behavior of the various cloud resources 104a, . . . , 104H of the cloud environment 100 over time, and facilitate in identifying anomalies that may indicate issues or opportunities for optimization.

As described above, in an example, the data streams 110 and/or 116 are stored at least temporarily in the storage repository 124. In an example, the data streams 110 and/or 116 are stored in a storage efficient format, such as a Parquet format. This reduces the data points to describe system behavior, while retaining insights about operation of the cloud resources 104a, . . . , 104H.

Thus, in an example, the data collection service 108 and the metric processing service 112 collect data streams 110a, . . . , 110N including metrics for a plurality of cloud resources 104a, . . . , 104H, analyze trends in such collected telemetry data, and summarize the incoming metrics and generates statistics and reliability metrices into data points of the data streams 116a, . . . , 116Q. The data streams 116a, . . . , 116Q reflect the health and behavior of the cloud resources 104a, . . . , 104H at discrete time intervals. As described above, the metric processing service 112 also processes the data streams 110a, . . . , 110N, to generate the statistics and reliability data streams 116a, . . . , 116Q, which provide trend data for the analyzed cloud resources 104a, . . . , 104H. Additionally, by summarizing the incoming metrics and storing the data streams 110 and/or 116 is a storage efficient format (such as the Parquet format), the total storage volume of the collected metrics within the storage repository 124 also is optimized or at least reduced. The data streams 110a, . . . , 110N and the data streams 116a, . . . , 116Q are representative of behavior of the cloud resources 104a, . . . , 104H being monitored. The data streams 110a, . . . , 110N and the data streams 116a, . . . , 116Q include multiple metrics that describe the behavior of the cloud resources 104a, . . . , 104H.

In an example, the cloud environment 100 also includes an autoencoder 120. The autoencoder 120 is a type of artificial neural network used for unsupervised learning tasks. In an example, the autoencoder 120 may be used for learning efficient coding of input data by capturing relevant features or patterns of the input data, while discarding redundant or less relevant information. The autoencoder 120 learns how to take in an input data, compress the input data, and then reconstruct the input data from the compressed data. The reconstruction is based on the expected system behavior that the autoencoder 120 was trained on.

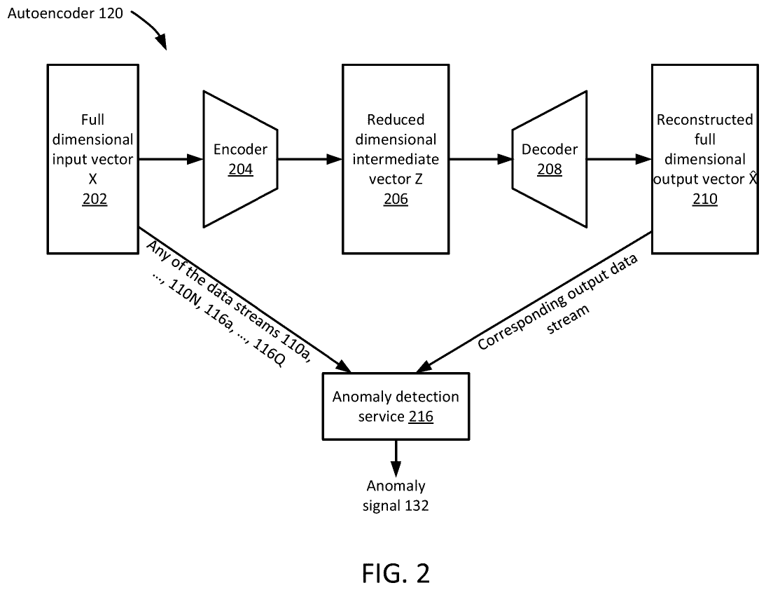

FIG. 2 illustrates an autoencoder, such as the autoencoder 120 of FIG. 1A. Referring to FIG. 2, the autoencoder 120 comprises an encoder 204 and a decoder 208. The encoder 204 receives input data, such as an input vector X 202. In an example, the input vector X 202 may have a relatively higher dimension (e.g., compared to a reduced dimensional intermediate vector Z 206 described below), and hence, the input vector X 202 is also referred to as a full dimensional input vector X 202.

Note that the encoder 204 may process several such input vectors X 202. Examples of the such input vectors X 202 received by the encoder 204 are one or more (such as all) of the data streams 110a, . . . , 110N, 116a, . . . , 116Q, as illustrated in FIG. 1A.

Referring again to FIG. 2, the encoder 204 encodes or compresses the input vector X 202 into a latent-space representation, also referred to as a reduced dimensional intermediate vector Z 206. The dimensionality of the intermediate vector Z 206 is less than that of the input vector X 202. For example, the intermediate vector Z 206 has relatively less data points compared to the input vector X 202. The intermediate vector Z 206 is a summarized representation of the input vector X 202.

The autoencoder 120 further comprises a decoder 208 that outputs a reconstructed full dimensional output vector \hat{X} 210 from this intermediate vector Z 206. In an example, the autoencoder 120 aims to reconstruct the input vector X 202 as the output vector \hat{X} 210. For example, the autoencoder 120 may be trained to minimize the difference between the input vector X 202 and its reconstruction version (which is the output vector \hat{X} 210). Thus, the output vector \hat{X} 210 is a reconstructed estimate of the input vector X 202. In an example, a loss function is used to train the autoencoder 120. An example of the loss function is Mean Squared Error (MSE). The reconstruction by the decoder is based on the expected system behavior that the autoencoder 120 was trained on.

In anomaly detection, the autoencoder 120 learns to represent “normal” data patterns during the training phase. For example, the autoencoder 120 is trained using such normal or non-anomalous data patterns of the data streams 110, 116. Here normal data pattern implies regular or normal data points (such as or non-anomalous data points) of a data stream 116 or 110 received by the autoencoder 120. For example, the normal data pattern of a data stream implies that the data stream does not include any major anomalous data points.

Assume that the autoencoder 120 is trained using such normal data patterns of the data streams 116 and/or 110. Subsequently, for example, when a normal data stream is fed to the trained autoencoder 120, the trained autoencoder 120 can output a reconstructed output data stream that is a reasonable estimate of the input data stream. However, if at least a part of the input data stream fed to the autoencoder 120 has anomalous data points, the trained autoencoder 120 may not be able to reproduce such anomalous data points at the output data stream.

Thus, when new data is fed through the trained autoencoder 120, the network of the autoencoder 120 can accurately reconstruct normal data points, but may be at least in part unable to reconstruct anomalous data points, resulting in higher reconstruction errors. Here reconstruction error is a difference between an input data stream and an output data stream.

For example, the autoencoder 120 is trained with normal or non-anomalous data points of one or more data streams. During inference stage of the trained autoencoder, when anomalous data points are fed to the trained autoencoder 120, the trained autoencoder 120 (such as the decoder 208) struggles to reconstruct the anomalous data points after the encoder 204 has compressed and reduced the size of the input data. If the data points are anomalous, the reconstructed output data significantly deviates from the input data. The autoencoder 120 (such as an anomaly detection service 216 of the autoencoder 120) measures the difference between the input and the output data with statistical means. This distance, when crosses a certain threshold, indicates anomaly in the data points, as described below in further detail.

Referring again to FIG. 1A, the autoencoder 120 receives one or more of (such as each of) the data streams 110a, . . . , 110N, 116a, . . . , 116Q, which are the input data streams to the autoencoder 120. The autoencoder 120 outputs reduced size data streams 128a, . . . , 128P. For example, each of the data streams 128a, . . . , 128P corresponds to one of the data streams 110a, . . . , 110N, 116a, . . . , 116Q. The reduced size data streams 128a, . . . , 128P are the intermediate latent space representation output by the encoder 204 of the autoencoder 120 (such as the reduced dimensional intermediate vector Z 206 of FIG. 2). Accordingly, the reduced size data streams 128a, . . . , 128P are more storage efficient than the full-sized data streams 110a, . . . , 110N, 116a, . . . , 116Q. For example, if the data stream 128a is generated by the encoder 204 from the data stream 110a or 116a, then the data stream 128a has lower dimension than the data stream 110a or 116a. Accordingly, storing the data stream 128a consumes less storage space than storing the data stream 110a or 116a. In an example, the reduced size data streams 128a, . . . , 128P are stored in the storage repository 124.

In an example, prior to providing the data streams 110a, . . . , 110N, 116a, . . . , 116Q to the autoencoder 120, the data streams are cleaned and preprocessed (e.g., handling missing values, normalization of the data streams, etc.). In another example, the data points may not be normalized. Note that the data streams 110a, . . . , 110N, 116a, . . . , 116Q represent a variety of metrices, and hence, may have different scales and ranges. In an example, a performance of the autoencoder 120 may be adversely affected, e.g., when the autoencoder 120 has to process the data streams having widely different scales and/or ranges.

Accordingly, in an example, one or more (such as all) data streams input to the autoencoder 120 may be normalized, prior to being provided to the autoencoder 120. In an example, normalizing or scaling the data points within a data stream provided to the autoencoder ensures that each feature or data point contributes approximately proportionately to the final distance. Also, normalizing the data points may reduce possibility of some data points of some data streams from having more influence than others.

In an example, assuming that the mean and standard deviation of the data points of a data stream is known, the data stream can be normalized using z score normalization. For example, a mean (μ) and a standard deviation (σ) of the data points within the data stream are initially calculated. Subsequently, each data point within the data stream is normalized using the following equation, in an example:

$$z = ( x - μ ) / σ . \qquad Equation 4$$

In another example, a minimum-maximum (min-max) scaling may be used for normalization, as follows:

$$Xnorm = [ \frac{X - X min}{X max - X min} ] . \qquad Equation 5$$

In an example, the autoencoder 120 may be trained using training data streams 110, 116, where the training data streams may be substantially devoid of anomalous data (e.g., the training data streams may include at most a threshold number of anomalous data points, where the threshold number may be zero, or relatively low compared to a total number of data points within the training data streams). For example, a training data stream generated from a cloud resource may include data points that reflect a normal or non-anomalous behavior of the cloud resource. For example, when the data points of a data stream are within a certain range (such as a configurable multiple of a standard deviation σ) of a mean of the data points, the data stream is referred to as a normal or non-anomalous data stream. However, an anomaly in the behavior of the cloud resource may result in anomalous data points, such that the data points are outside such a range, and such a data stream may be referred to as an anomalous data stream. In an example and as described above, training of the autoencoder 120 is performed using non-anomalous data streams, such that the trained autoencoder 120 learns to reproduce an output vector \hat{X} 210 to be a reasonably accurate estimate of the input vector X 202, when the input vector X 202 is a non-anomalous data stream. However, if the trained autoencoder 120 receives an anomalous data stream, the trained autoencoder 120 may not be able to accurately reproduce the output vector \hat{X} 210 to be a reasonably accurate estimate of the input vector X 202. After the training of the autoencoder 120 is complete (e.g., using non-anomalous data streams), the autoencoder 120 may be provided with anomalous and/or non-anomalous data streams, e.g., based on actual operating conditions of the cloud resources 104.

In an example, during training the autoencoder 120, the loss function may be based on a reconstruction error, which is defined as follows:

$$Reconstruction error = {‖ X - \hat{X} ‖}^{2} . \qquad Equation 5 A$$

In equation 5A, X is the input vector 202, and \hat{X} is the output vector 210, wherein as described above, the input vector X 202 comprises a non-anomalous data stream during training of the autoencoder 120. Note that for the cloud environment 100 and for each input data stream provided to the autoencoder 120, a stream of reconstruction errors is generated corresponding to a plurality of data points within the input data stream.

In an example, the autoencoder 120 may sequentially or at least in part (or fully) parallelly process multiple data streams. For example, it may be advantageous to process multiple data streams at once, as this allows the autoencoder 120 to learn the relationships between different metrics of the different data streams. However, if the metrics of the different data streams are relatively highly uncorrelated, then separate and multiple autoencoders 120 may be used for different types of the data streams.

For example, two or more data streams may be correlated to each other. For example, assume that (i) a first data stream is indicative of a number of requests processed by a cloud resource every second, and (ii) a second data stream is indicative of a latency experienced by requests at the cloud resource every second. The two data streams are correlated. In an example, the autoencoder 120 may also be trained to analyze the interdependencies and correlations between these two data streams, e.g., for multivariate anomaly detection. For example, if a first data point of the first data stream is high and a corresponding first data point of the second data stream is high or low, then the cloud resource is doing its intended job (e.g., processing requests at a high rate). If a second data point of the first data stream is low and a corresponding second data point of the second data stream is also low, then the cloud resource is doing its intended job (e.g., processing requests as it comes to the cloud resource). However, if a third data point of the first data stream is low and a corresponding third data point of the second data stream is high, then the latency is high, and requests processed per second is low—this implies that the cloud resource may be failing to do its intended job. Thus, the autoencoder may corelate the stream of reconstruction errors for the first data stream and the stream of reconstruction errors for the second data stream (or may corelate the first data stream and the second data stream), to detect the one or more data points within the first data stream and another one or more data points within the second data stream as being anomalous data points. The anomalous data points may be because the corresponding cloud resource is not able to process incoming requests in a desired manner, e.g., due to a failure or non-optimized operation of the cloud resource, or due to a failure of a memory or cache or a network component associated with the cloud resource.

In an example, the autoencoder 120 comprises one or more of (i) a number of input layers corresponding to a number of data streams to be handled by the autoencoder, (ii) one or more hidden layers for encoding and reducing dimensions, (iii) a bottleneck layer for the compressed or reduced dimension representation of the intermediate vector Z 206, and (ii) a plurality of symmetric layers for decoding. In an example, activation functions suitable for the data streams being processed by the autoencoder 120 may be used. Examples of such activation functions include rectified linear unit (ReLU) for hidden layers, and/or sigmoid or tanh for the output layer (e.g., if the data is normalized between 0 and 1).

Once the autoencoder 120 is trained, the autoencoder 120 is used to generate anomaly signals 132a, . . . , 132S. For example, referring again to FIG. 2, the autoencoder 120 also includes an anomaly detection service 216, which provides a difference between the input vector X 202 and the output vector \hat{X} 210. For a given data stream provided to the autoencoder 120, the autoencoder 120 may selectively pass or fail the data stream (e.g., declares the data stream to be free of anomaly, or includes anomalous data points) as follows. For each data point within the data stream, a corresponding z score of its reconstruction error is calculated. The z score indicates how many standard deviations the error is from the mean. The z score is calculated as follows:

$$Z = \frac{Reconstruction error - µ}{σ} . \qquad Equation 6$$

In equation 6, μ is the mean and σ is the standard deviation of the data points of the data stream within a time window (described above). Note that for the cloud environment 100 and for each input data stream provided to the autoencoder 120, a stream of z score is generated corresponding to a plurality of data points within the input data stream.

In an example, the anomaly detection service 216 detects the z score of each data point of a data stream, and compares the z score to a preconfigured threshold. Each data point of a data stream provided to the autoencoder 120 are assigned an anomalous or non-anomalous flag or label (e.g., by the anomaly detection service 216) as follows:

z score of a data point>Threshold, then the data point is anomalous; or

z score of the data point<Threshold, then the data point is non-anomalous. Equation 7

The threshold of equation 7 may be set to a suitable value, e.g., based on a desired sensitivity for anomaly detection. For example, for a relatively more sensitive anomaly detection system (e.g., where relatively small deviation from the mean may be considered anomalous) may have a relatively lower threshold, and vice versa. In an example, the threshold can be set to 2, or 3, or another desired value. By setting a threshold on the reconstruction error, data points with errors above this threshold can be flagged as anomalies, thus enabling the detection of unusual or abnormal behavior in the data points of a data stream. If an anomaly is detected within one or more data points of a data stream, a corresponding anomaly signal 132 is generated, where the anomaly signal 132 is indicative of anomalous data points within the data stream.

Thus, the data streams 110a, . . . , 110N, 116a, . . . , 116Q are processed by the trained autoencoder 120. The autoencoder 120 performs the following function(s): for each data stream provided to the autoencoder, (i) generates a reduced size data stream 128 that has a smaller size compared to the original data stream provided to the autoencoder 120, and (ii) detects anomalies, if any, for one or more data points within the data stream, and generates a corresponding anomaly signal 132 accordingly.

The reduced size data stream 128 corresponding to a data stream 110 or 116 provided to the autoencoder 120 facilitates in storing of a summarized version of the data points of the data stream 110 or 116, e.g., in a compact and storage efficient format. Furthermore, the autoencoder 120 is used to identify trends and anomalies in the data points, as described above.

In an example, the above-described threshold of equation 7 may be dynamically adjusted, e.g., by a human operator, automatically, or by a machine learning model. The threshold may be adjusted based on a time of the day, a day of the week, based on sessional or otherwise expected temporal variations in the data points, or based on a distribution of the reconstruction errors observed during the autoencoder training of metrics data from metrics to identify anomalies.

For example, in the morning and evenings, rapid fluctuations in demand of a cloud resource may be normal. However, such rapid fluctuations at midnight or early morning may be anomalous. Accordingly, the threshold may be set higher during the daytime, and may be kept low at midnight or early morning.

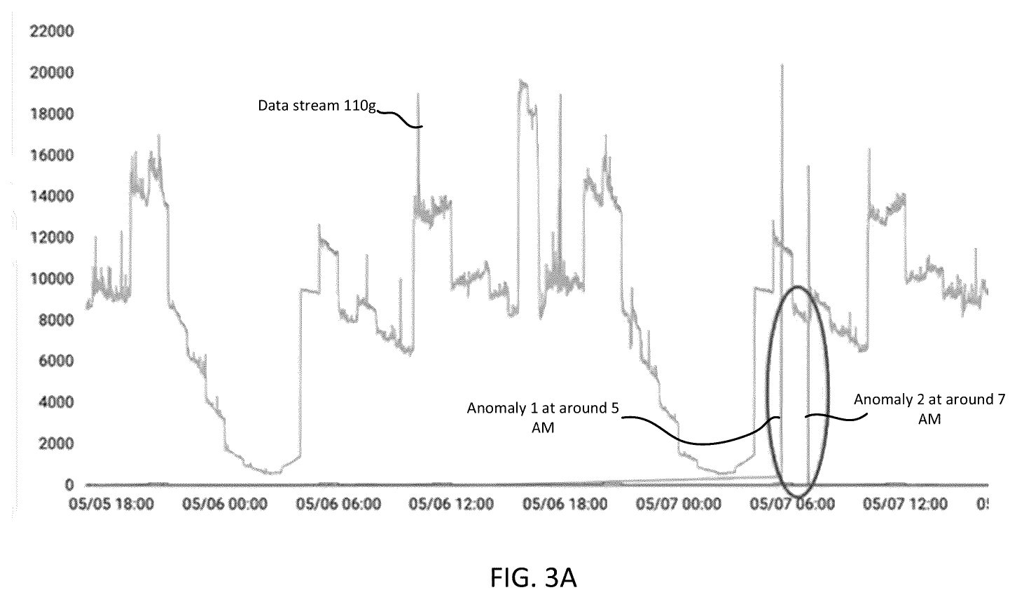

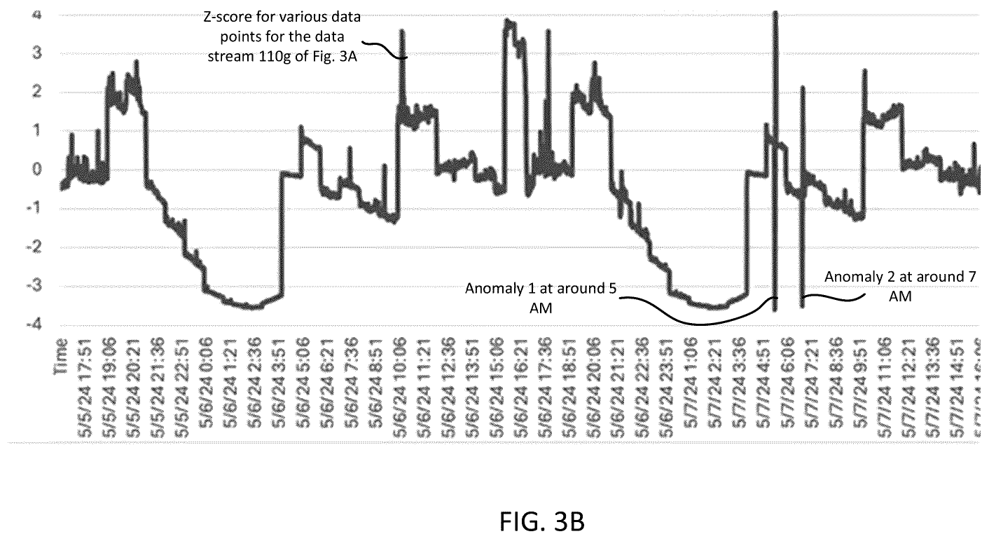

FIG. 3A illustrates example data points of an example data stream 110g, and FIG. 3B illustrates the z score for various data points for the data stream 110g of FIG. 3A. Note that although FIGS. 3A and 3B are associated with the example data stream 110g, these figures can be applicable to any of the data streams 110a, . . . , 110N, 116a, . . . , 116Q.

As illustrated in FIG. 3A, the data stream 110g illustrates data points collected over about a two-day period. As seen, the data stream 110g exhibits a daily cycle, where a process gets triggered at about 4:00 AM and starts a gradual decline at about 10:00 PM. However, there are two anomalies in the data stream 110g: (i) an anomaly 1 at around 5 AM where demand momentarily decreases sharply followed by sharp rise in demand, and (ii) an anomaly 2 at around 7 AM where again the demand momentarily decreases sharply followed by sharp rise in demand.

FIG. 3B illustrates the corresponding z scores for the various data points. Note that the absolute value of the z score is high at night (e.g., between 10 PM and 4 AM), as the process using the corresponding resource wraps down during this period. Accordingly, in an example, the threshold of equation 7 may be kept relatively high during this period (e.g., between 10 PM and 4 AM). However, the threshold of equation 7 may be kept relatively low at other times (e.g., between 4 AM and 10 PM), when the process is up and running. For example, the threshold may be 3.8 between 4 AM and 10 PM, and the threshold may be 5 between 10 PM and 4 AM. Accordingly, although the absolutely value of the z score at nighttime (e.g., between 10 PM and 4 AM) may be as high as the anomalous events 1 and 2, because of the difference in the thresholds, the non-anomalous variations in the z scores between 10 PM and 4 AM does not trigger an anomaly alert (e.g., as the nighttime threshold is high). However, as the daytime threshold is relatively low, the anomalous events 1 and 2 occurring during the daytime is detected by the anomaly detection service 216.

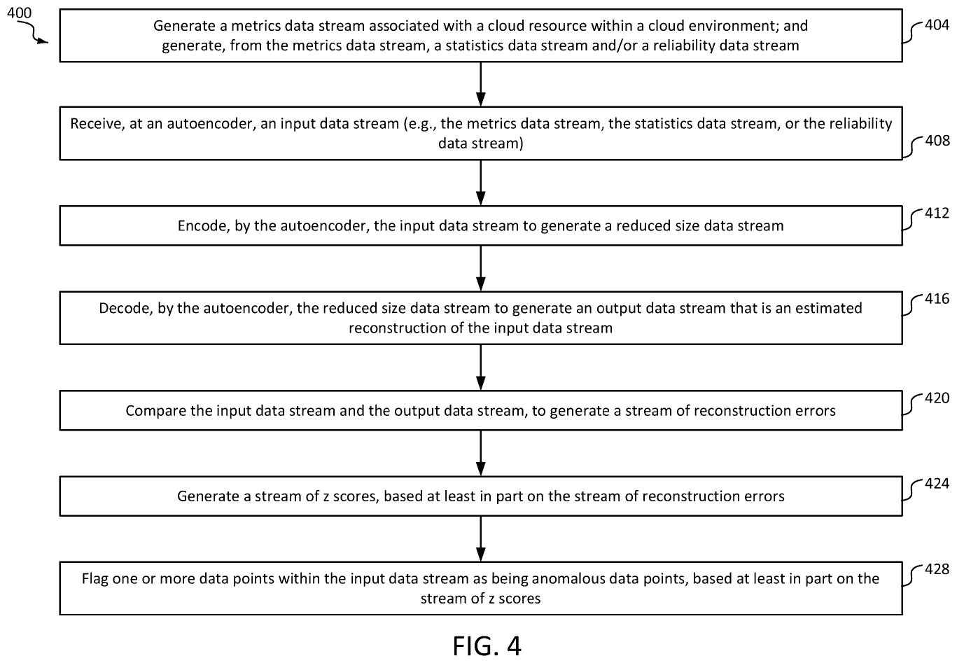

FIG. 4 is a flow diagram depicting a method 400 of using an autoencoder for anomaly detection and/or efficient storage of metrics data within a cloud environment.

At 404, a metrics data stream associated with a cloud resource within a cloud environment is generated. For example, as illustrated in FIG. 1A, metrics data streams 110a, . . . , 110N are generated, which are associated with the cloud resources 104a, . . . , 104H. Also at 404, from the metrics data stream, a statistics data stream and/or a reliability data stream are generated. For example, statistics data streams and/or reliability data streams 116a, . . . , 116Q are generated from the metrics data stream 110a, . . . , 110N.

At 408, at an autoencoder, an input data stream is received, where the input data stream is any of the metrics data stream, the statistics data stream, or the reliability data stream.

At 412, the autoencoder (such as the encoder 204 of the autoencoder 120) encodes the input data stream to generate a reduced size data stream (such as a compressed data stream), e.g., as described above with respect to FIG. 2.

At 416, the autoencoder (such as the decoder 208 of the autoencoder 120) decodes the reduced size data stream to generate an output data stream that is an estimated reconstruction of the input data stream, e.g., as also described above with respect to FIG. 2.

At 420, the autoencoder (such as the anomaly detection service 216 of the autoencoder 120) compares the input data stream and the output data stream, to generate a stream of reconstruction errors. For example, a data point of the input data stream is compared to a corresponding data point of the output data stream, to generate a corresponding reconstruction error of the stream of reconstruction errors (e.g., see equation 5A described above). Note that the input data stream and the output data stream may have the same dimension, which is higher than a dimension of the reduced size data stream.

At 424, the autoencoder (such as the anomaly detection service 216 of the autoencoder 120) generates a stream of z scores, based at least in part on the stream of reconstruction errors. Generating a z score associated with a data point has been described above with respect to equation 6.

At 428, the autoencoder (such as the anomaly detection service 216 of the autoencoder 120) flags one or more data points within the input data stream as being anomalous data points, based at least in part on the stream of z scores. For example, a z score of a data point of the input data stream is compared to a threshold, to determine whether the data point is anomalous, e.g., as described above with respect to equation 7. In an example, the threshold is adjusted dynamically, as also described above.

At 432, the cloud environment 100 (such as the autoencoder) causes to at least one of (i) detect an erroneous operation of the cloud resource or (ii) rectify an erroneous operation of the cloud resource. For example, the one or more data points within the input data stream being flagged as anomalous data points implies that the corresponding cloud resource may have an operational health issues. Accordingly, a health of the cloud resource is checked (e.g., by a human operation by or another automated manner), which may detect an erroneous operation of the cloud resource. In an example, such an erroneous operation of the cloud resource may be rectified, e.g., by a human operation by or another automated manner.

### Computer System Architecture

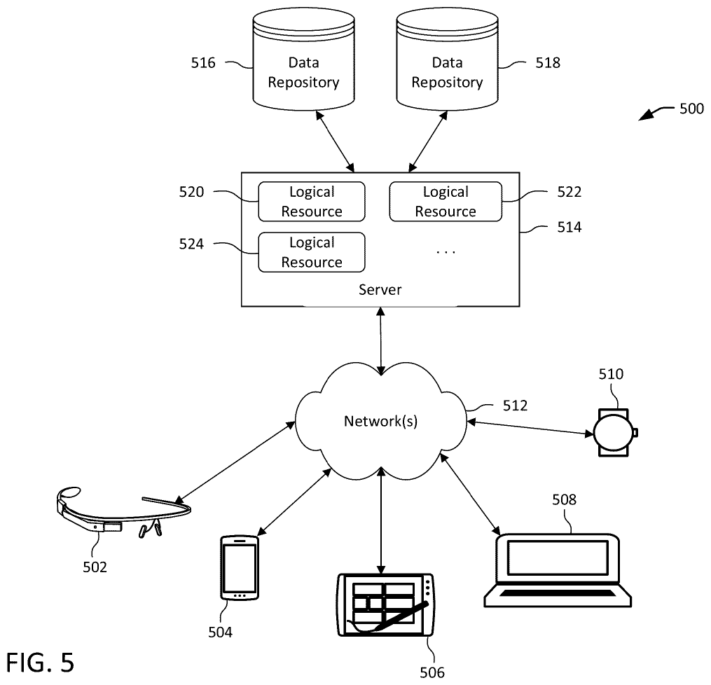

FIG. 5 depicts a simplified diagram of a distributed system 500 for implementing an embodiment. In the illustrated embodiment, distributed system 500 includes one or more client computing devices 502, 504, 506, 508, and/or 510 coupled to a server 514 via one or more communication networks 512. Clients computing devices 502, 504, 506, 508, and/or 510 may be configured to execute one or more applications.

In various aspects, server 514 may be adapted to run one or more services or software applications that enable techniques for implementing an autoencoder for anomaly detection and efficient storage of metrics data in a cloud environment.

In certain aspects, server 514 may also provide other services or software applications that can include non-virtual and virtual environments. In some aspects, these services may be offered as web-based or cloud services, such as under a Software as a Service (SaaS) model to the users of client computing devices 502, 504, 506, 508, and/or 510. Users operating client computing devices 502, 504, 506, 508, and/or 510 may in turn utilize one or more client applications to interact with server 514 to utilize the services provided by these components.

In the configuration depicted in FIG. 5, server 514 may include one or more components 520, 522 and 524 that implement the functions performed by server 514. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, 508, and/or 510 for techniques for implementing an autoencoder for anomaly detection and efficient storage of metrics data in a cloud environment. A client device may provide an interface that enables a user of the client device to interact with the client device. The client device may also output information to the user via this interface. Although FIG. 5 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch™, and other devices), and the like. The client devices may be capable of executing various different applications such as various Internet-related apps, communication applications (e.g., e-mail applications, short message service (SMS) applications) and may use various communication protocols.

Network(s) 512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth™, and/or any other wireless protocol), and/or any combination of these and/or other networks.

Server 514 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 514 can include one or more virtual machines running virtual operating systems, or other computing architectures involving virtualization such as one or more flexible pools of logical storage devices that can be virtualized to maintain virtual storage devices for the server. In various aspects, server 514 may be adapted to run one or more services or software applications that provide the functionality described in the foregoing disclosure.

The computing systems in server 514 may run one or more operating systems including any of those discussed above, as well as any commercially available server operating system. Server 514 may also run any of a variety of additional server applications and/or mid-tier applications, including HTTP (hypertext transport protocol) servers, FTP (file transfer protocol) servers, CGI (common gateway interface) servers, JAVA servers, database servers, and the like. Exemplary database servers include without limitation those commercially available from Oracle®, Microsoft®, SAP®, Amazon®, Sybase®, IBM® (International Business Machines), and the like.

In some implementations, server 514 may include one or more applications to analyze and consolidate data feeds and/or event updates received from users of client computing devices 502, 504, 506, 508, and/or 510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 514 may also include one or more applications to display the data feeds and/or real-time events via one or more display devices of client computing devices 502, 504, 506, 508, and/or 510.

Distributed system 500 may also include one or more data repositories 516, 518. These data repositories may be used to store data and other information in certain aspects. For example, one or more of the data repositories 516, 518 may be used to store information for techniques for implementing an autoencoder for anomaly detection and efficient storage of metrics data in a cloud environment. Data repositories 516, 518 may reside in a variety of locations. For example, a data repository used by server 514 may be local to server 514 or may be remote from server 514 and in communication with server 514 via a network-based or dedicated connection. Data repositories 516, 518 may be of different types. In certain aspects, a data repository used by server 514 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 516, 518 may also be used by applications to store application data. The data repositories used by applications may be of different types such as, for example, a key-value store repository, an object store repository, or a general storage repository supported by a file system.

In one embodiment, server 514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

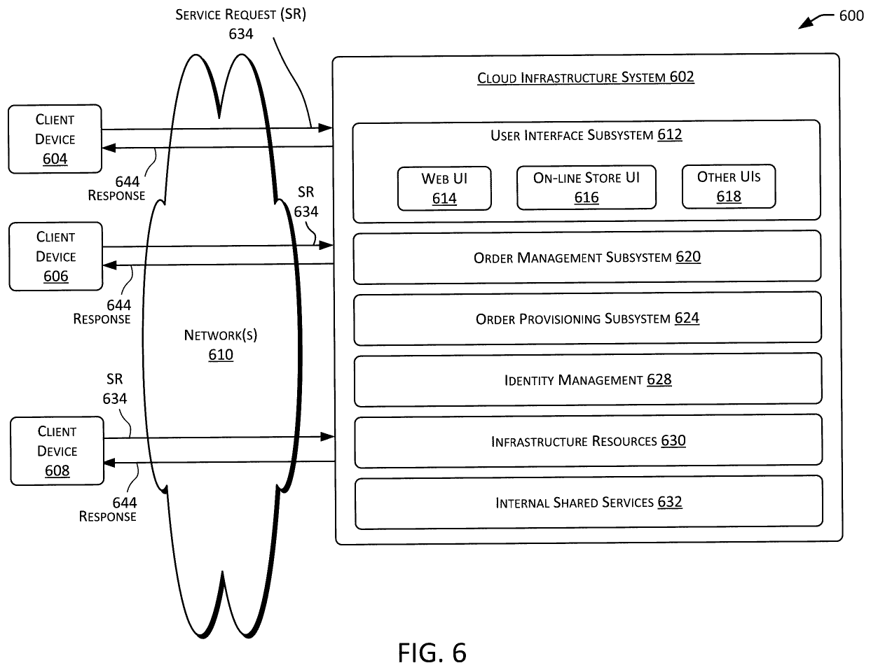

FIG. 6 is a simplified block diagram of a cloud-based system environment in which an autoencoder may perform anomaly detection and facilitate in efficient storage of metrics data of a cloud environment, in accordance with certain aspects. In the embodiment depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 512. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The embodiment depicted in FIG. 6 is only one example of a cloud infrastructure system and is not intended to be limiting. It should be appreciated that, in some other aspects, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative aspects.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 610 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 602 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 602 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 602. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 602. Cloud infrastructure system 602 then performs processing to provide the services requested in the tenant's subscription order. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public tenant, where the tenant can be an individual or an enterprise. In certain other aspects, under a private cloud model, cloud infrastructure system 602 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 602 and the services provided may be shared by several organizations in a related community. Various other models such as hybrids of the above mentioned models may also be used.

Client computing devices 604, 606, and 608 may be of different types (such as devices 502, 504, 506, and 508 depicted in FIG. 5) and may be capable of operating one or more client applications. A user may use a client device to interact with cloud infrastructure system 602, such as to request a service provided by cloud infrastructure system 602.

In some aspects, the processing performed by cloud infrastructure system 602 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 602 for determining the intent of an utterance. The data used for this analysis may include structured data (e.g., data stored in a database or structured according to a structured model) and/or unstructured data (e.g., data blobs (binary large objects)).

As depicted in the embodiment in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like.

In certain aspects, to facilitate efficient provisioning of these resources for supporting the various cloud services provided by cloud infrastructure system 602 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a tenant may, using a client device, request (service request 634) one or more services provided by cloud infrastructure system 602 using one or more of interfaces 614, 616, and 618. For example, a tenant may access the online store, browse cloud services offered by cloud infrastructure system 602, and place a subscription order for one or more services offered by cloud infrastructure system 602 that the tenant wishes to subscribe to. The service request may include information identifying the tenant and one or more services that the tenant desires to subscribe to.

In certain aspects, such as the embodiment depicted in FIG. 6, cloud infrastructure system 602 may comprise an order management subsystem (OMS) 620 that is configured to process the new order. As part of this processing, OMS 620 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 620 may then invoke the order provisioning subsystem (OPS) 624 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 602 may send a response or notification 644 to the requesting tenant to indicate when the requested service is now ready for use. In some instances, information (e.g., a link) may be sent to the tenant that enables the tenant to start using and availing the benefits of the requested services.

Cloud infrastructure system 602 may provide services to multiple tenants. For each tenant, cloud infrastructure system 602 is responsible for managing information related to one or more subscription orders received from the tenant, maintaining tenant data related to the orders, and providing the requested services to the tenant or clients of the tenant. Cloud infrastructure system 602 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 602 may provide services to multiple tenants in parallel. Cloud infrastructure system 602 may store information for these tenants, including possibly proprietary information. In certain aspects, cloud infrastructure system 602 comprises an identity management subsystem (IMS) 628 that is configured to manage tenant's information and provide the separation of the managed information such that information related to one tenant is not accessible by another tenant. IMS 628 may be configured to provide various security-related services such as identity services, such as information access management, authentication and authorization services, services for managing tenant identities and roles and related capabilities, and the like.

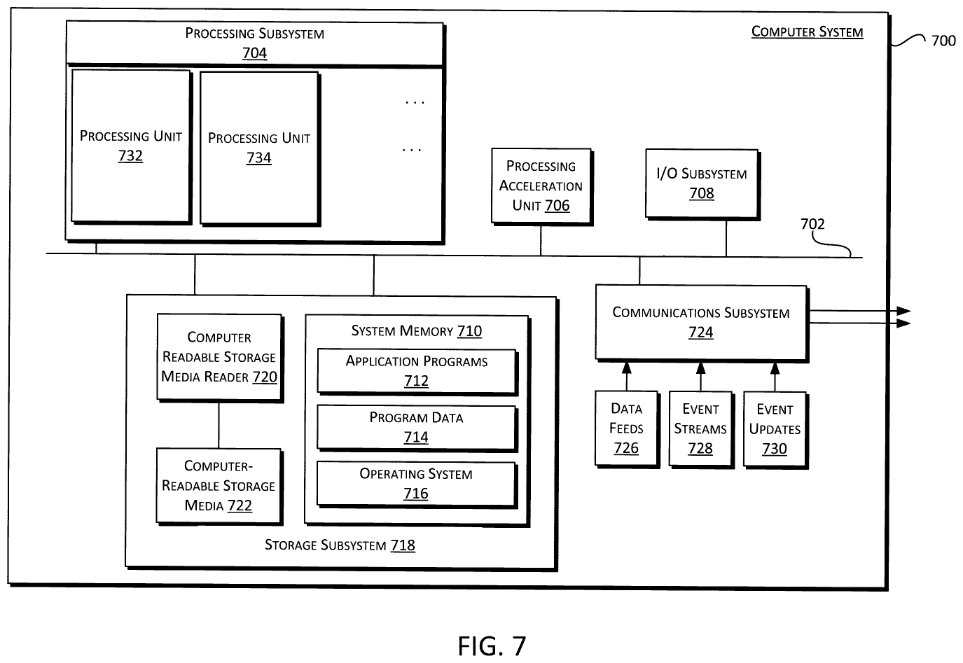

FIG. 7 illustrates an exemplary computer system 700 that may be used to implement certain aspects. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative aspects of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some aspects, processing subsystem 704 can include one or more special purpose co-processors such as graphics processors, digital signal processors (DSPs), or the like. In some aspects, some or all of the processing units of processing subsystem 704 can be implemented using customized circuits, such as application specific integrated circuits (ASICs), or field programmable gate arrays (FPGAs).

In some aspects, the processing units in processing subsystem 704 can execute instructions stored in system memory 710 or on computer readable storage media 722. In various aspects, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain aspects, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some aspects. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 722 may store programming and data constructs that provide the functionality of some aspects. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, digital video disc (DVD), a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 718 may also include a computer-readable storage media reader 720 that can further be connected to computer-readable storage media 722. Reader 720 may receive and be configured to read data from a memory device such as a disk, a flash drive, etc.

In certain aspects, computer system 700 may support virtualization technologies, including but not limited to virtualization of processing and memory resources. For example, computer system 700 may provide support for executing one or more virtual machines. In certain aspects, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices.

Communication subsystem 724 may support both wired and/or wireless communication protocols. For example, in certain aspects, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 724 can provide wired network connectivity (e.g., Ethernet) in addition to or instead of a wireless interface.

Communication subsystem 724 can receive and transmit data in various forms. For example, in some aspects, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A non-transitory computer-readable medium including instructions that when executed by one or more processors, cause a system including the one or more processors to perform operations including:
receiving, from a cloud resource operating within a cloud environment, an input data stream indicative of a metric associated with the cloud resource, the input data stream including a plurality of data points indicative of values of the metric at a corresponding plurality of points in time;
encoding, by an autoencoder, the input data stream to generate a reduced size data stream;
decoding, by the autoencoder, the reduced size data stream to generate an output data stream that is an estimated reconstruction of the input data stream;
comparing the input data stream and the output data stream, to generate a stream of reconstruction errors;
generating a stream of z scores, based at least in part on the stream of reconstruction errors; and
flagging one or more data points within the input data stream as being anomalous data points, based at least in part on the stream of z scores.

2. The non-transitory computer-readable medium of claim 1, wherein flagging the one or more data points within the input data stream as being anomalous data points comprises:
in response to one or more z scores of the stream of z scores being higher than a corresponding one or more thresholds, flagging the one or more data points within the input data stream as being anomalous data points.

3. The non-transitory computer-readable medium of claim 2, wherein flagging the one or more data points within the input data stream as being anomalous data points comprises:
generating (i) a first z score corresponding to a first data point of the input data stream, (ii) a second z score corresponding to a second data point of the input data stream, and (iii) a third z score corresponding to a third data point of the input data stream;
comparing each of the first and second z scores with a first threshold, and comparing the third z score with a second threshold;
in response to the first z score being higher than the first threshold, flagging the first data point within the input data stream as being an anomalous data point;
in response to second z score being lower than the first threshold, determining that the second data point within the input data stream is a non-anomalous data point; and
in response to third z score being higher than the second threshold, flagging the third data point within the input data stream as being an anomalous data point.

4. The non-transitory computer-readable medium of claim 3, wherein the first threshold is different from the second threshold.

5. The non-transitory computer-readable medium of claim 3, wherein the operations further include:
determining the first threshold, based at least in part on a first time and a second time at which the first data point and the second data point, respectively, were generated; and
determining the second threshold, based at least in part on a third time at which the third data point was generated.

6. The non-transitory computer-readable medium of claim 3, wherein the operations further include:
determining the first and second thresholds dynamically, based at least in part on a distribution of reconstruction errors observed during a training phase of the autoencoder.

7. The non-transitory computer-readable medium of claim 1, wherein the input data stream is a first input data stream, the reduced size data stream is a first reduced size data stream, the output data stream is first output data stream, the stream of reconstruction errors is first stream of reconstruction errors, and the stream of z scores is a first stream of z scores, and wherein the operations further include:
receiving, from the cloud resource operating within a cloud environment, a second input data stream indicative of another metric associated with the cloud resource;
encoding, by the autoencoder, the second input data stream to generate a second reduced size data stream;
decoding, by the autoencoder, the second reduced size data stream to generate a second output data stream that is an estimated reconstruction of the second input data stream;
comparing the second input data stream and the second output data stream, to generate a second stream of reconstruction errors; and
corelating the first stream of reconstruction errors and the second stream of reconstruction errors, to detect the one or more data points within the first input data stream and another one or more data points within the second input data stream as being anomalous data points.

8. The non-transitory computer-readable medium of claim 1, wherein the operations further include:
storing the reduced size data stream, wherein a size of the reduced size data stream is less than a size of the input data stream.

9. The non-transitory computer-readable medium of claim 8, wherein the operations further include:
storing the input data stream and the reduced size data stream; and
deleting the stored input data stream after a period of time, without deleting the reduced size data stream.

10. The non-transitory computer-readable medium of claim 8, wherein the reduced size data stream is stored in a Parquet format.

11. The non-transitory computer-readable medium of claim 1, wherein the input data stream is a first input data stream, the metric is a first metric, and wherein the operations further include:
generating, from the cloud resource operating within the cloud environment, a second input data stream indicative of a second metric associated with the cloud resource; and
generating, from the second input data stream, the first input data stream indicative of the first metric associated with the cloud resource, wherein the first metric is a statistic measure or a reliability measure.

12. The non-transitory computer-readable medium of claim 11, wherein the statistic measure or the reliability measure comprises a statistic measure including one of a total count of data points of the second input data stream within a sequence of time windows, a maximum value of the data points of the second input data stream within the sequence of time windows, a minimum value of the data points of the second input data stream within the sequence of time windows, a mean value of the data points of the second input data stream within the sequence of time windows, a P95 value of the data points of the second input data stream within the sequence of time windows.

13. The non-transitory computer-readable medium of claim 11, wherein the statistic measure or the reliability measure comprises a reliability measure including one of a mean time between failures of the cloud resource within a sequence of time windows, percentage availability of the cloud resource within a sequence of time windows, and a weighted moving average of the first metric within a sequence of time windows.

14. The non-transitory computer-readable medium of claim 1, wherein the input data stream is a first input data stream, and wherein the operations further include:
training the autoencoder using a plurality of input data streams that (i) excludes the first input data stream and (ii) that includes at most a threshold number of anomalous data points.

15. The non-transitory computer-readable medium of claim 1, wherein the operations further include:
in response to the one or more data points within the input data stream being flagged as being anomalous data points, causing to at least one of (i) detect an erroneous operation of the cloud resource or (ii) rectify an erroneous operation of the cloud resource.

16. A method comprising:
receiving, from a cloud resource operating within a cloud environment, an input data stream indicative of a metric associated with the cloud resource, the input data stream including a plurality of data points indicative of values of the metric at a corresponding plurality of points in time;
encoding, by an autoencoder, the input data stream to generate a reduced size data stream;
decoding, by the autoencoder, the reduced size data stream to generate an output data stream that is an estimated reconstruction of the input data stream;
comparing the input data stream and the output data stream, to generate a stream of reconstruction errors;
generating a stream of z scores, based at least in part on the stream of reconstruction errors; and
flagging one or more data points within the input data stream as being anomalous data points, based at least in part on the stream of z scores.

17. The method of claim 16, wherein flagging the one or more data points within the input data stream as being anomalous data points comprises:
in response to one or more z scores of the stream of z scores being higher than a corresponding one or more thresholds, flagging the one or more data points within the input data stream as being anomalous data points.

18. The method of claim 16, wherein the input data stream is a first input data stream, and wherein the method further comprises:
training the autoencoder using a plurality of input data streams that (i) excludes the first input data stream and (ii) that includes at most a threshold number of anomalous data points.

19. A system comprising:
one or more processors;
a storage repository; and
one or more non-transitory computer-readable media storing instructions, which, when executed by the system, cause the system to perform a set of actions including:
receiving, from a cloud resource operating within a cloud environment, an input data stream indicative of a metric associated with the cloud resource, the input data stream including a plurality of data points indicative of values of the metric at a corresponding plurality of points in time;
encoding, by an autoencoder, the input data stream to generate a reduced size data stream;
storing the reduced size data stream in the storage repository;
decoding, by the autoencoder, the reduced size data stream to generate an output data stream that is an estimated reconstruction of the input data stream;
comparing the input data stream and the output data stream, to generate a stream of reconstruction errors;
generating a stream of z scores, based at least in part on the stream of reconstruction errors; and
flagging one or more data points within the input data stream as being anomalous data points, based at least in part on the stream of z scores.

20. The system of claim 19, wherein flagging the one or more data points within the input data stream as being anomalous data points comprises:
in response to one or more z scores of the stream of z scores being higher than a corresponding one or more thresholds, flagging the one or more data points within the input data stream as being anomalous data points.

21. The system of claim 20, wherein the input data stream is a first input data stream, the metric is a first metric, and wherein the operations further include:
generating, from the cloud resource operating within the cloud environment, a second input data stream indicative of a second metric associated with the cloud resource; and
generating, from the second input data stream, the first input data stream indicative of the first metric associated with the cloud resource, wherein the first metric is a statistic measure or a reliability measure.
